(19) United States
(12) Patent Application Publication
(10) Pub. No.: US 2013/0169481 A1
(43) Pub. Date: Jul. 4, 2013

(54) WIRELESS COMMUNICATION APPARATUS AND WIRELESS COMMUNICATION METHOD

(71) Applicants: Yuya Takatsuka, Tokyo (JP); Yukimasa Nagai, Tokyo (JP); Toshinori Hori, Tokyo (JP)

(72) Inventors: Yuya Takatsuka, Tokyo (JP); Yukimasa Nagai, Tokyo (JP); Toshinori Hori, Tokyo (JP)

(73) Assignee: Mitsubishi Electric Corporation, Tokyo (JP)

(21) Appl. No.: 13/821,423

(22) PCT Filed: Dec. 13, 2011
(86) PCT No.: PCT/JP2011/078824

§ 371 Date: Mar. 7, 2013

(30) Foreign Application Priority Data
Dec. 20, 2010 (JP) 2010-283507

(51) Int. Cl. H01Q 3/34

(52) U.S. Cl. CPC H01Q 3/34
USPC 342/372

(57) ABSTRACT

A wireless communication apparatus includes a BT-apparatus unit configured to perform wireless communication using frequency hopping, a WLAN-apparatus unit configured to perform wireless communication in a system different from a system of the BT-apparatus unit using a band including at least a part of a band used by the BT-apparatus unit and using a WLAN-antenna whose directionality is controllable, and an information managing unit configured to, upon detecting simultaneous communication of the BT-apparatus unit and the WLAN-apparatus unit, instruct the WLAN-apparatus unit to perform communication while adjusting a beam direction of the WLAN-antenna and instruct the BT-apparatus unit to measure a communication quality, determine a directionality setting value of the WLAN-antenna based on the communication quality measurement by the BT-apparatus unit, and instruct the WLAN-apparatus unit to perform communication using the determined directionality setting value.

### FIELD

The present invention relates to a wireless communication apparatus and a wireless communication method adapted to two communication systems that use the same frequency band and are capable of simultaneously performing kinds of communications corresponding to the communication systems.

### BACKGROUND

In a 2.4 GHz band called ISM (Industry Science Medical) band, a user can use a radio apparatus without a license as long as the user satisfies standards stipulated in the Radio Act. Therefore, radio apparatuses that use this frequency band have been actively developed in recent years in wireless LAN (Local Area Network) (IEEE (The Institute of Electrical and Electronics Engineers” 802.11b/g/n), Bluetooth (registered trademark), cordless telephone, and the like.

In a radio communication apparatus employing IEEE802.11b/g/n (hereinafter referred to as WLAN (Wireless LAN) apparatus), a direct sequence spread spectrum (DSSS) as a direct diffusion system or OFDM (Orthogonal Frequency Division Multiplexing) technique is introduced taking into account an anti-noise property (see, for example, Non-Patent Literature 1 listed below). This WLAN apparatus performs communication fixedly using one of predetermined fourteen channels in an ISM band of the 2.4 GHz band (hereinafter referred to as WLAN channels). Each WLAN channel has an occupied bandwidth (22 MHz) equivalent to about twenty channels used by a Bluetooth (registered trademark) apparatus, and an interval between adjacent channels has 5 MHz. A center frequency band of the WLAN channels is allocated in a range of 2.412 GHz to 2.484 GHz.

In the WLAN apparatus, a CSMA/CA (Carrier Sense Multiple Access with Collision Avoidance) system is mainly introduced as a wireless access system taking into account interoperability between the WLAN apparatus and an other network or other system. In the CSMA/CA system, each WLAN apparatus carrier-senses a radio channel prior to wireless packet transmission. When it is confirmed by the carrier sense that the channel is in use (channel busy), the WLAN apparatus stands by for transmission of wireless packets, and transmits the wireless packets after a channel nonuse (channel idle) time and a back-off time determined for each frame type in advance elapse.

On the other hand, in a radio communication apparatus adapted to Bluetooth (registered trademark) (hereinafter referred to as BT apparatus), a frequency hopping spread spectrum (FHSS) technique is introduced taking into account an anti-noise property (see, for example, Non-Patent Literature 2 listed below). Specifically, the BT apparatus adopts a frequency hopping system for selecting one FH channel among 79 frequency channels (hereinafter referred to as FH channels) each having a width of 1 MHz set in a frequency band from 2.40 GHz to 2.48 GHz and performing radio communication while switching, as time elapses, an FH channel to be selected. In the frequency hopping system, an FH channel is selected at every fixed time interval (e.g., 625 μs) based on a pseudo random algorithm determined in advance, and one packet data piece is allocated to the selected FH channel to perform communication.

As explained above, both the BT apparatus and the WLAN apparatus use the 2.4 GHz band. Therefore, when the BT apparatus and the WLAN apparatus are mutually present in communication areas of the WLAN apparatus and the BT apparatus, radio waves transmitted by the BT apparatus and the WLAN apparatus interfere with each other and mutually hinder communications thereof. As a method of avoiding such radio wave interference, there is a technique called adaptive frequency hopping (AFH). In this technique, the BT apparatus measures a bit error rate (BER), a packet error rate (PER) and the like during transmission or measures a reception signal intensity in a slot not used for communication among BT apparatuses, to thereby observe the quality of an FH channel on the BT apparatus side (susceptibleness to a failure from another system such as WLAN apparatus). The BT apparatus prevents interference from another system such as WLAN by performing frequency hopping avoiding an FH channel in which it is determined based on a result of the observation that a radio wave that hinders communication of the BT apparatus is present.

There is also disclosed a method of detecting a reception level and performing beam forming in an AP (Access Point) of a WLAN so as to limit an interference wave from an interference wave generation source such as another radio system or a microwave oven that uses the same frequency band to make it possible to communicate with a radio terminal (see, for example, Patent Literature 1). In this system, the AP is able to form a plurality of directional beams having the maximum directionality in different directions and measures a reception level of an RTS (Request to Send) transmitted by the radio terminal, thereby to select a directional beam to be used for communication with the RTS transmission terminal based on the reception level.

### CITATION LIST

### Patent Literature

Patent Literature 1: Japanese Patent Application Laid-open No. 2003-018074

### Non Patent Literature

Non-Patent Literature 1: IEEE, “IEEE Std IEEE802.11-2007”, 12 Jun. 2007
Non-Patent Literature 2: Bluetooth (registered trademark), “Specification of Bluetooth System Covered Core Package Version: 3.0+HS”, 21 Apr. 2009

### SUMMARY

### Technical Problem

However, in the above-mentioned conventional AFH technique, a channel currently used in WLAN communication is excluded from FH channels usable in BT communication. For this reason, in a situation in which a large number of WLAN terminals are present in the periphery and a plurality of channels are used, there is a problem in that the number of FH channels usable in the BT communication decreases and the communication quality of the BT communication is deteriorated (e.g., decrease in throughput and increase in a propagation delay time are caused).

Besides, there is a technique in which a radio apparatus mounted with functions of both of the WLAN apparatus and the BT apparatus and configured to perform both of the WLAN communication and the BT communication puts transmission of one transmission (the WLAN communication or the BT communication) in a standby mode and limits interference between the WLAN communication and the BT communication according to the priority of a packet called PTA (Packet Traffic Arbitration). However, even in the technique, because transmission by one of the WLAN communication and the BT communication is put in a standby mode, there is a problem in that the communication quality on the side in the standby mode is deteriorated.

The present invention has been devised in view of the above circumstances and it is an object of the present invention to obtain a wireless communication apparatus and a wireless communication method that can limit interference with other communication in an environment in which a plurality of radio communication systems that use the same frequency band are mixed.

### Solution to Problem

In order to solve the above-mentioned problems and achieve the object, the present invention provides a wireless communication apparatus comprising: a first communication unit configured to perform wireless communication in which frequency hopping is used; a second communication unit configured to perform wireless communication in a system different from a system of the first communication unit using a band including at least a part of a band used by the first communication unit and making use of a directional antenna whose directionality is controllable; and a control unit configured to, upon detecting simultaneous communication performed by the first communication unit and the second communication unit, instruct the second communication unit to perform communication while adjusting a beam direction of the directional antenna and instruct the first communication unit to measure a communication quality, determine a directionality setting value of the directional antenna based on a result of the communication quality measurement obtained by the first communication unit, and instruct the second communication unit to perform communication using the determined directionality setting value.

### Advantageous Effects of Invention

According to the present invention, there is an effect that it is possible to limit two kinds of communication, which use the same frequency band and perform communications in systems different from each other, from interfering with each other and improve the communication quality of communication in which frequency hopping is used.

### BRIEF DESCRIPTION OF DRAWINGS

FIG. 1 is a diagram showing a configurational example of a wireless communication apparatus of a first embodiment according to the present invention.

FIG. 2 is a diagram showing a configurational example of a wireless communication system including the wireless communication apparatus according to the present invention.

FIG. 3 is a diagram showing one example of a positional relation between a BT terminal and a WLAN terminal.

FIG. 4 is a sequence chart showing one example of an interference avoiding method according to the first embodiment.

FIG. 5 is a chart showing one example of a method of storing an estimation result of a BT terminal location.

FIG. 6 is a chart showing one example of a method of storing a determination result of a beam direction.

FIG. 7 is a flowchart showing one example of a method of estimating a location of the BT terminal;

FIG. 8 is a flowchart showing one example of an interference avoiding method used when BT communication is started after WLAN communication is started.

FIG. 9 is a diagram showing a configurational example of a wireless communication apparatus of a second embodiment according to the present invention.

FIG. 10 is a diagram showing one example of a positional relation between a BT terminal and a WLAN terminal.

FIG. 11 is a sequence chart showing one example of an interference avoiding method according to the second embodiment.

FIG. 12 is a chart showing one example of a method of storing a location estimation result of the WLAN terminal.

FIG. 13 is a flowchart showing one example of a determination operation in a method of avoiding interference between the WLAN communication and the BT communication.

FIG. 14 is a diagram showing a configurational example of a wireless communication apparatus of a third embodiment according to the present invention.

FIG. 15 is a diagram showing a configurational example of a wireless communication system including the wireless communication apparatus according to the third embodiment.

FIG. 16 is a diagram showing one example of a positional relation between a BT terminal and a WLAN terminal.

FIG. 17 is a sequence chart showing one example of an interference avoiding method according to the third embodiment.

FIG. 18 is a chart showing one example of a method of storing WLAN terminal information.

### DESCRIPTION OF EMBODIMENTS

Embodiments of a wireless communication apparatus and a wireless communication method according to the present invention are described in detail below with reference to the drawings. The present invention is not limited to these embodiments.

### First Embodiment

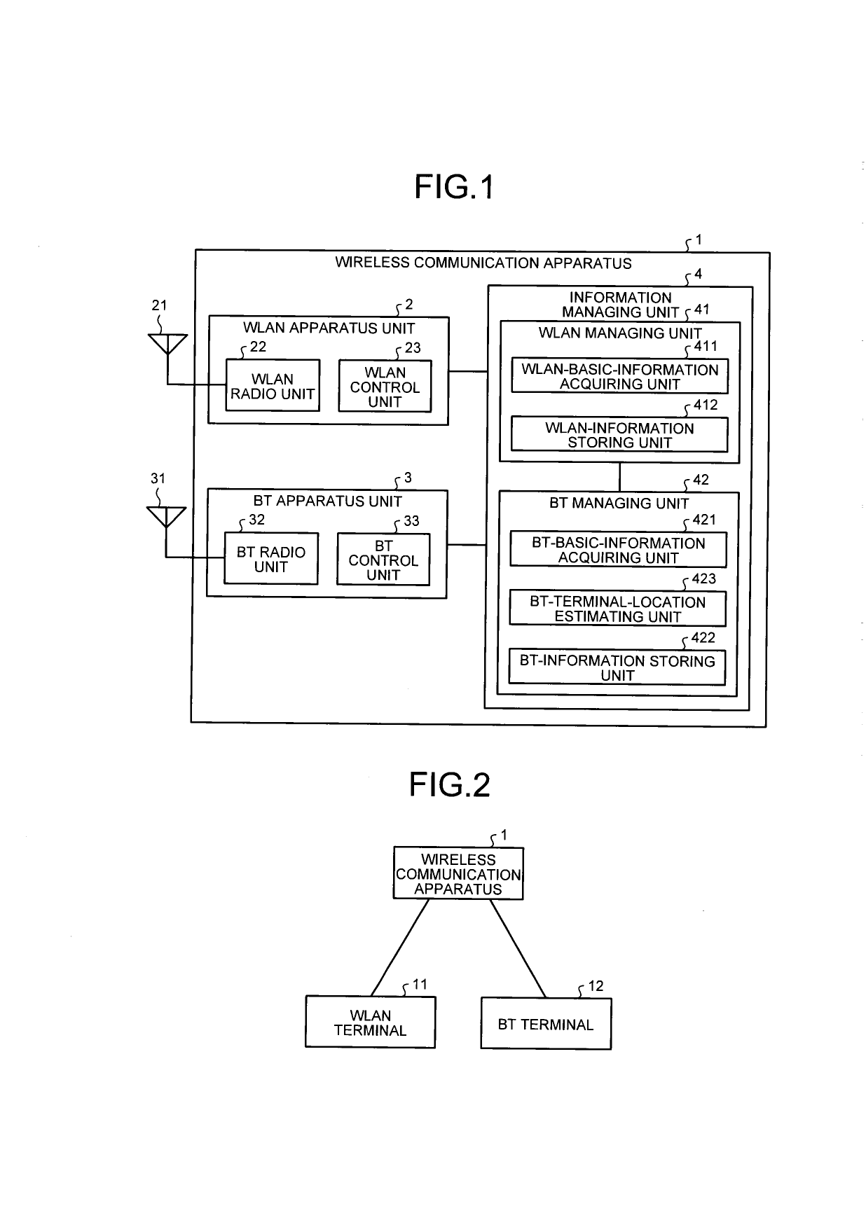

FIG. 1 is a diagram of a configuration example of a first embodiment of a wireless communication apparatus according to the present invention. As shown in FIG. 1, a wireless communication apparatus 1 according to this embodiment includes a WLAN apparatus unit 2, which is a communication apparatus adapted to a wireless LAN (IEEE802.11b/g/n) standard, a BT apparatus unit 3, which is a communication apparatus adapted to a BT standard, and an information managing unit 4 that performs control of the WLAN apparatus unit 2 and the BT apparatus unit 3 and manages information concerning the WLAN apparatus unit 2 and the BT apparatus unit 3. The WLAN apparatus unit 2 and the BT apparatus unit 3 perform kinds of communications complied with different communication systems in parallel, respectively, according to instructions of the information managing unit 4. In FIG. 1, main components of the WLAN apparatus unit 2, the BT apparatus unit 3 and the information managing unit 4 are also shown.

The WLAN apparatus unit 2 is composed of a WLAN antenna 21, a WLAN radio unit 22, a WLAN control unit 23, and a transmission and reception signal amplifying unit, a filter, a modulation and demodulation processing unit, and the like which are not shown in the figure. It is assumed that the WLAN antenna 21 is an antenna capable of performing transmission and reception in an arbitrary direction, for example, a sector antenna having directionality in four directions. It is assumed that the WLAN antenna 21 is capable of performing not only directional communication but also communication of non-directionality. The WLAN antenna 21 may be a sector antenna having directionality in a plurality of directions, a smart antenna capable of forming a beam in an arbitrary direction, an antenna capable of performing beam forming, an antenna that searches for a device in the periphery and forms an optimum beam pattern, a phased array antenna, or the like, and so is not limited to the sector antenna.

The BT apparatus unit 3 is composed of a BT antenna 31, a BT radio unit 32, a BT control unit 33, a not-shown interface unit interfacing with a host controller, and the like. It is assumed that the BT antenna 31 is a non-directional antenna and the BT apparatus unit 3 has an AFH function (adaptive frequency hopping function).

The information managing unit 4 includes a WLAN managing unit 41 that manages information related to WLAN and a BT managing unit 42 that manages information related to BT. The information managing unit 4 operates as control means and outputs an instruction concerning respective kinds of communication of the WLAN apparatus unit 2 and the BT apparatus unit 3 to the WLAN apparatus unit 2 and the BT apparatus unit 3. The information managing unit 4 acquires connection terminal information, frequency information of a frequency to be used, and the like from the WLAN apparatus unit 2 and the BT apparatus unit 3.

The WLAN managing unit 41 includes a WLAN-basic-information acquiring unit 411 and a WLAN-information storing unit 412. The WLAN-basic-information acquiring unit 411 acquires an ID (e.g., a MAC address), support information of QoS, corresponding rate information, and the like of a connected WLAN terminal. The WLAN-information storing unit 412 stores these kinds of information. The WLAN-information storing unit 412 also stores information concerning a WLAN channel used by the WLAN apparatus unit 2.

The BT managing unit 42 includes a BT-basic-information acquiring unit 421, a BT-information storing unit 422, and a BT-terminal-location estimating unit 423. The BT-basic-information acquiring unit 421 acquires an ID (e.g., a MAC address), BT version information, and the like of a connected BT terminal. The BT-information storing unit 422 stores these kinds of information. The BT-information storing unit 422 also stores an AFH channel map indicating an FH channel usable in AFH in the BT apparatus unit 3. The BT-terminal-location estimating unit 423 estimates a location of a BT terminal to be connected in cooperation with the WLAN apparatus unit 2 and the BT apparatus unit 3. The BT-information storing unit 422 stores information concerning the estimated location. A method of estimating a location of a BT terminal is described later.

A timing for the WLAN managing unit 41 and the BT managing unit 42 in the information managing unit 4 to respectively acquire information from the WLAN apparatus unit 2 and the BT apparatus unit 3 may be a method of automatically notifying, when an event occurs in the WLAN apparatus unit 2 or the BT apparatus unit 3, the information managing unit 4 of, as communication information, information generated or acquired in that event. Alternatively, the method may be a method in which the information managing unit 4 notifies, periodically or at arbitrary timing, the WLAN apparatus unit 2 and the BT apparatus unit 3 of an instruction for requesting information collection. These methods may be properly used according to information and/or an apparatus.

FIG. 2 is a diagram of a configurational example of a wireless communication system including the wireless communication apparatus according to the present invention. As shown in FIG. 2, the wireless communication system includes the wireless communication apparatus 1 shown in FIG. 1, a WLAN terminal 11 that performs WLAN communication, and a BT terminal 12 that performs BT communication.

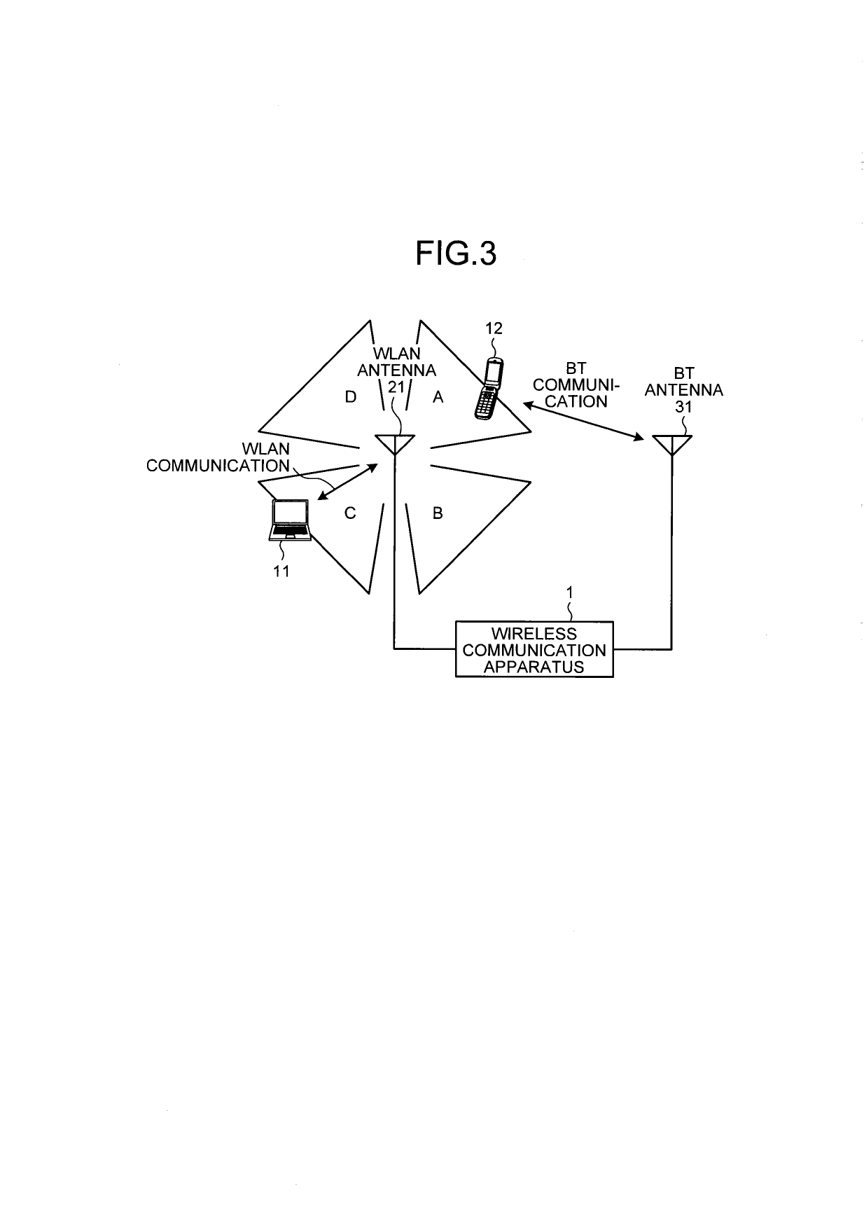

In this embodiment, it is assumed that, as shown in FIG. 3, the WLAN antenna 21 has directionality in four directions (A, B, C and D) and the WLAN terminal 11 and the BT terminal 12 are respectively located in different WLAN beam directions. In FIG. 3, although the WLAN terminal 11 is located in the C direction of a WLAN beam and the BT terminal 12 is located in the A direction of the WLAN beam, such arrangement of the WLAN terminal 11 and the BT terminal 12 is not particularly limited to this example as long as the WLAN terminal 11 and the BT terminal 12 are respectively located in different directions. Besides, although the WLAN antenna 21 has the directionality in the four directions, the number of sectors of the WLAN antenna 21 is not specifically limited.

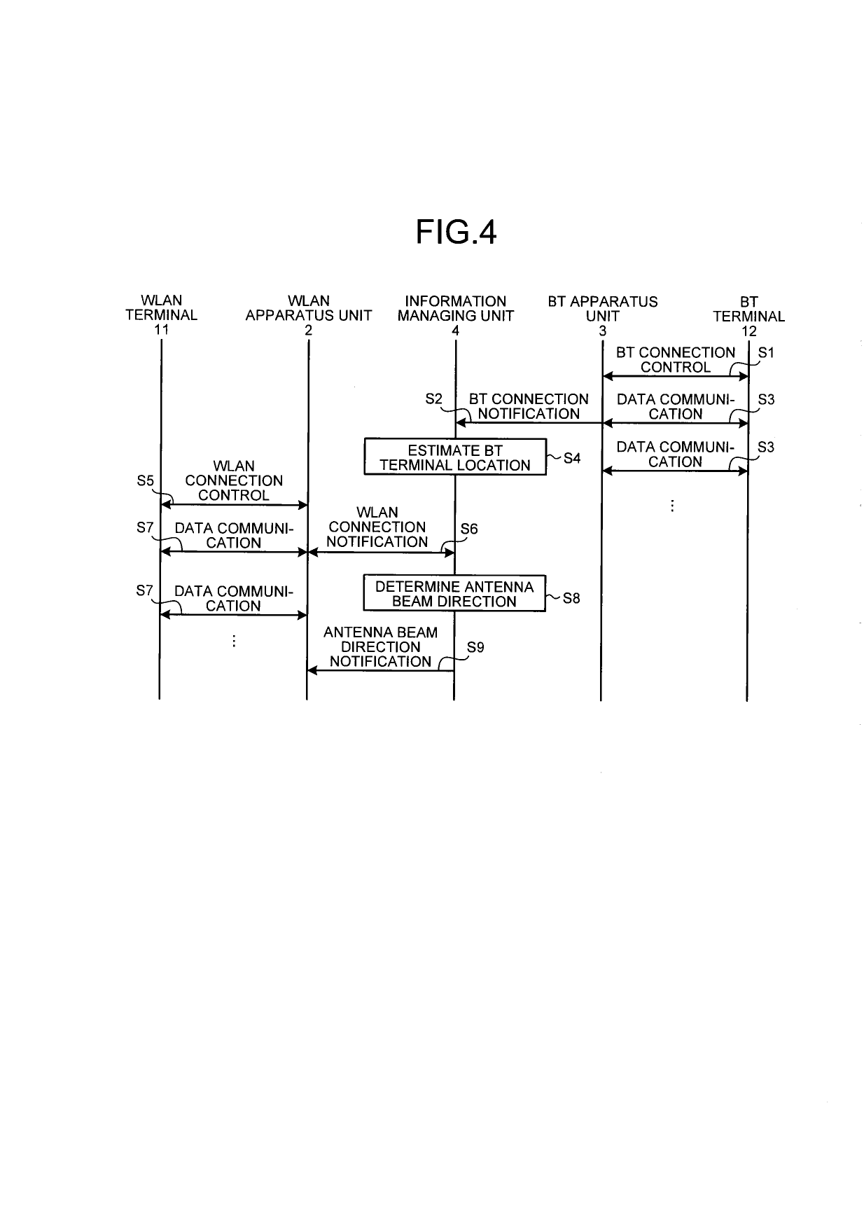

An interference avoiding method according to this embodiment is explained with reference to FIG. 4. FIG. 4 is a sequence chart showing an example of the interference avoiding method according to this embodiment. In FIG. 4, a sequence based on the configurations shown in FIGS. 2 and 3 is shown in which, after the BT terminal 12 is connected to the wireless communication apparatus 1, the WLAN terminal 11 is connected to the wireless communication apparatus 1.

First, the BT apparatus unit 3 of the wireless communication apparatus 1 performs connection control processing for BT communication with the BT terminal 12 (step S1). The connection control processing for BT communication is the same as that in the past.

After the connection control processing for BT communication is completed, the BT apparatus unit 3 sends, to the information managing unit 4, a BT connection notification for notifying that BT connection has been completed (step S2). In the BT connection notification, for example, a MAC address of a connected BT terminal and AFH channel map information used for the BT communication are stored.

On the other hand, after the BT connection control processing is completed, data transmission and reception by the BT communication is performed between the BT apparatus unit 3 of the wireless communication apparatus 1 and the BT terminal 12 (step S3).

In the information managing unit 4 that has received the BT connection notification and detected communication start of the BT apparatus unit 3, information (the MAC address of the BT terminal, the AFH channel map information, etc.) acquired by the BT connection notification is provided to the BT-basic-information acquiring unit 421 of the BT managing unit 42 as BT terminal information. Then, the acquired BT terminal information is stored in the BT-information storing unit 422. Further, upon recognizing connection of the BT terminal 12, the BT-terminal-location estimating unit 423 executes location estimation for the BT terminal 12 (step S4). A method of estimating a location of the BT terminal 12 is explained below. An estimation result of a BT terminal location is, for example, a beam direction of a relevant WLAN antenna. The estimation result of the BT terminal location may be, for example, direction information and, in an automobile, a seat position, and it is only necessary that the location of the BT terminal 12 can be recognized by the result. The estimation result of the BT terminal location is not limited to the beam direction of the WLAN antenna. The location estimation result of the BT terminal 12 is stored in the BT-information storing unit 422. Stored contents are, for example, set as shown in FIG. 5. In an example shown in FIG. 5, the MAC address of the BT terminal 12, the AFH channel map information and location information of the BT terminal 12 (herein, the beam direction of the WLAN antenna) are stored in association with one another. Stored contents are not limited to this example.

In the information managing unit 4, when the BT connection notification is received, the WLAN managing unit 41 is notified that the BT connection is performed (the BT communication is started) with the BT terminal 12.

After the processing at steps S1 to S4 is executed, the WLAN apparatus unit 2 of the wireless communication apparatus 1 performs WLAN connection control processing between the WLAN apparatus unit 2 and the WLAN terminal 11 (step S5). Connection control processing for WLAN communication is the same as that in the past.

After the connection control processing for the WLAN communication is completed, the WLAN apparatus unit 2 sends, to the information managing unit 4, a WLAN connection notification for notifying that the WLAN connection is completed (step S6). In the WLAN connection notification, for example, a MAC address of a connected WLAN terminal and information concerning a WLAN channel used for the WLAN communication are stored.

On the other hand, after the WLAN communication control processing is completed, data transmission and reception by the WLAN communication is performed between the WLAN apparatus unit 2 of the wireless communication apparatus 1 and the WLAN terminal 11 (step S7).

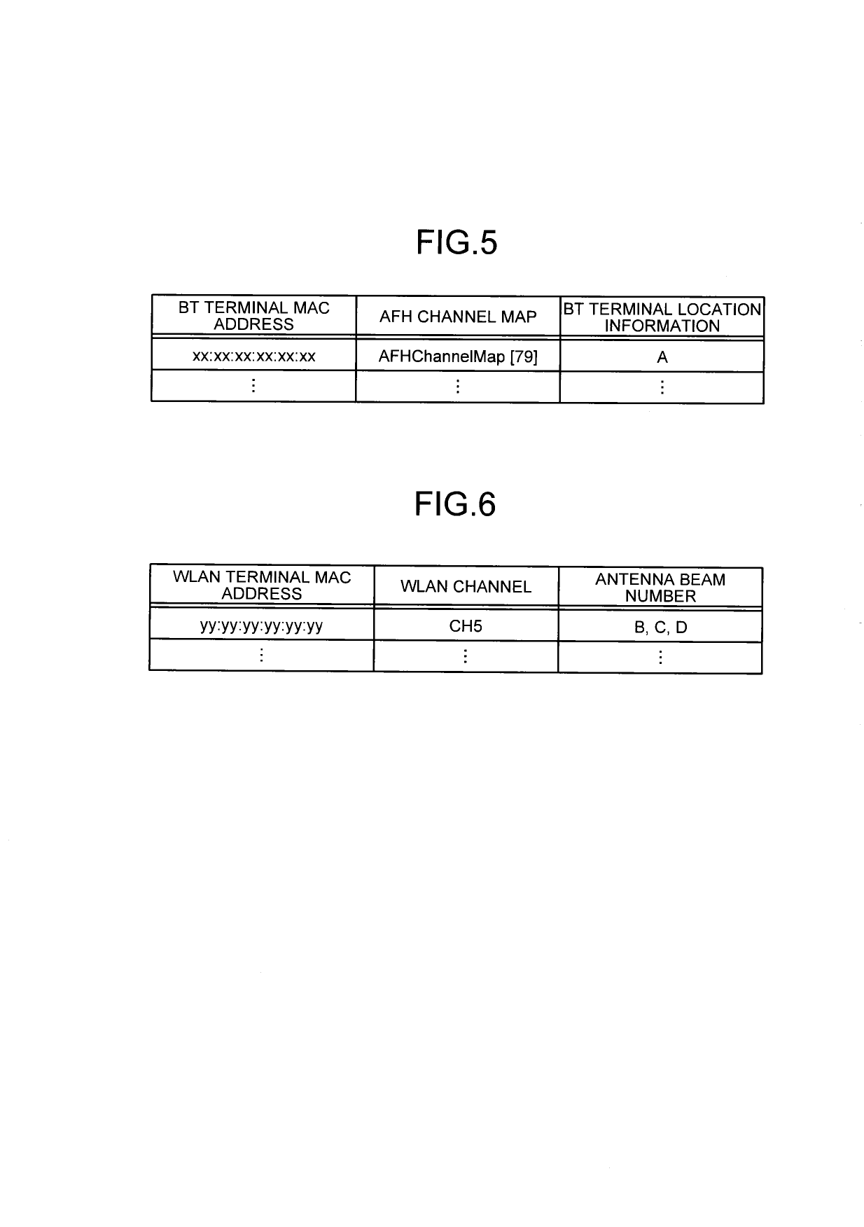

In the information managing unit 4 that has received the WLAN connection notification and detected communication start of the WLAN apparatus unit 2, information (the MAC address of the WLAN terminal, the WLAN channel information, etc.) acquired by the WLAN connection notification is provided to the WLAN-basic-information acquiring unit 411 of the WLAN managing unit 41 as WLAN terminal information. Then, the acquired WLAN terminal information is stored in the WLAN-information storing unit 412. Further, the WLAN managing unit 41 that recognizes the connection of the BT terminal 12 acquires the location information of the BT terminal 12 stored in the BT-information storing unit 422, and determines a beam direction of the WLAN antenna 21 to direct a NULL point of directionality to a direction in which the BT terminal 12 is located (step S8). The determined beam direction is stored in the WLAN-information storing unit 412. Stored contents are, for example, set as shown in FIG. 6. In an example shown in FIG. 6, the MAC address of the WLAN terminal 11, the WLAN channel and a WLAN antenna beam number of a WLAN antenna to be used are stored in association with one another. The stored contents are not limited to this example.

Upon determining the beam direction of the WLAN antenna 21, the information managing unit 4 notifies the WLAN apparatus unit 2 of the determined antenna beam direction (step S9). In the antenna beam direction notification, the antenna beam information determined at the step S8 is stored. Upon receiving the antenna beam direction notification, the WLAN apparatus unit 2 communicates with the WLAN terminal 11 using the provided antenna beam.

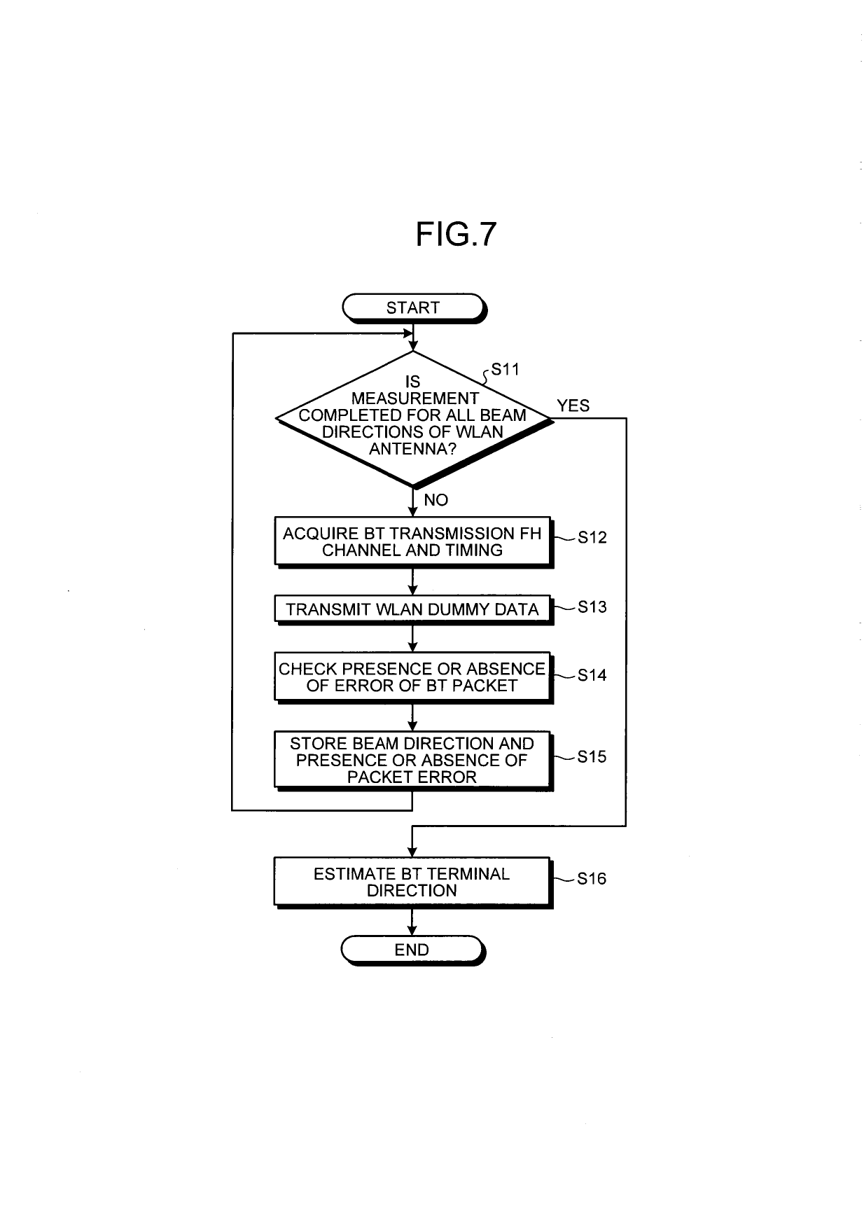

Now, a method of estimating the location of the BT terminal 12 at the step S4 is explained. FIG. 7 is a flowchart showing an example of a method of estimating the location of the BT terminal. FIG. 7 is just one example. The order and contents of processing are not limited to this example, and any method may be adopted as long as the location of the BT terminal 12 can be estimated.

In the BT terminal location estimating method in the flowchart shown in FIG. 7, the information managing unit 4 acquires an FH channel and transmission timing transmitted by the BT terminal 12. The information managing unit 4 transmits WLAN dummy data in a designated WLAN beam direction using timing same as timing when the BT terminal 12 performs BT transmission and using a WLAN channel including the FH channel. The information managing unit 4 carries out this processing in all beam directions and estimates a BT terminal location from presence or absence of an error of a BT packet.

As shown in FIG. 7, in an operation for estimating a BT terminal location, first, the BT-terminal-location estimating unit 423 checks whether or not processing (error presence or absence measurement for a BT packet) shown at steps S12 to S15 explained below has been completed for all the beam directions of the WLAN antenna 21 (step S11). As a result of the check, when the measurement has been completed (Yes at step S11), the BT-terminal-location estimating unit 423 transitions to a step S16.

On the other hand, when the measurement has not been completed (No at step S11), the BT-terminal-location estimating unit 423 acquires transmission FH channels in the BT communication and timing of transmission in each FH channel (step S12). These kinds of information can be acquired from AFH channel map information included in BT terminal information stored in the BT-information storing unit 422.

Subsequently, the BT-terminal-location estimating unit 423 instructs the WLAN apparatus unit 2 to transmit dummy data in a designated arbitrary beam direction in the timing of when BT transmission in which an arbitrary FH channel is used, using a WLAN channel including the FH channel, and causes the WLAN apparatus unit 2 to transmit dummy data (step S13). The beam direction in which the dummy data are transmitted is set to a beam direction in which the error presence or absence measurement for a BT packet has not been completed in the preceding processing so far.

Subsequently, the BT-terminal-location estimating unit 423 acquires, from the BT apparatus unit 3, presence or absence of an error of a packet in a period in which the dummy data is transmitted at the step S13 (step S14). The BT-terminal-location estimating unit 423 stores the beam direction indicated (designated) to the WLAN apparatus unit 2 in the transmission instruction at the step S13 and the presence or absence of an error of the packet acquired at the step S14 (step S15). For the presence or absence of an error of the packet, presence of an error is confirmed when an error occurrence ratio of the packet reaches a threshold determined in advance, for example. Alternatively, the error occurrence ratio itself may be stored rather than the presence or absence of an error. After executing the step S15, the BT-terminal-location estimating unit 423 returns to the step S11 and determines whether or not the measurement is to be continued.

Upon determining at the step S11 that the measurement is not to be continued, i.e., the steps S12 to S15 have been repeatedly executed for all the beam directions of the WLAN antenna 21 and the error presence or absence measurement for the BT packet has been performed (Yes at the step S11), the BT-terminal-location estimating unit 423 determines, from the information stored at the step S15 (information indicating, concerning each of all the WLAN beam directions, whether an error of the BT packet occurs), whether a BT terminal is located in a WLAN beam direction in which the error occurs (step S16). If the BT-terminal-location estimating unit 423 is configured to store the error occurrence ratio at the step S15, then the BT-terminal-location estimating unit 423 determines that a BT terminal is located in a WLAN beam direction in which the error occurrence ratio is the highest.

In the example shown in FIG. 7, the processing at the steps S12 to S15 is executed for all the beam directions of the WLAN antenna 21. However, there is another alternative in which a BT terminal direction is decided on at a point when an error of the BT packet occurs, so as to omit processing in the remaining WLAN beam directions.

In addition, there is a further alternative configuration adapted to execute the processing at the steps S12 to S15 a plurality of times for one WLAN beam direction and estimate that the BT terminal 12 is located in a WLAN beam direction in which the number of BT packet errors having occurred is the greatest.

Further, a channel of WLAN may be fixed, and the dummy data may be transmitted according to timing in which transmission using an FH channel in a WLAN channel is performed.

For example, the dummy data may be transmitted in a specific WLAN antenna beam direction and the number of FH channels usable in the AFH of the BT communication at a point of the transmission may be acquired from the BT apparatus unit 3. The process may be performed for all the directions to make it possible to estimate that a BT terminal is located in a direction in which the number of usable FH channels is the smallest.

In the method of estimating a BT terminal based on the number of usable FH channels, the dummy data may be transmitted designating a NULL point of the WLAN antenna only in a specific direction to make it possible to determine that a BT terminal is located in a NULL direction in which the number of FH channels usable in the AFH is the largest.

As another BT terminal location estimating method, the BT-terminal-location estimating unit 423 causes the WLAN apparatus unit 2 to execute carrier sense for a designated WLAN antenna beam direction for a fixed time of period and acquires the number of times a signal estimated as BT is detected by the carrier sense (the number of times a reception power level equal to or higher than a predetermined threshold is detected). This process may also be executed in all the beam directions to make it possible to determine that a BT terminal is located in a direction in which the number of times the signal is detected by the carrier sense is the largest.

In the BT terminal location estimating method based on the WLAN carrier sense, the number other than in the WLAN (beam directions having a certain degree of a reception power level, although not reaching a carrier sense level of the WLAN) may be measured based on a carrier sense threshold to make it possible to estimate a direction in which the number of measurements is the largest to be a BT terminal location direction.

In the sequence shown in FIG. 4, the antenna beam direction is determined after the WLAN data communication at the step S7 is started. However, the WLAN apparatus unit 2 may start the WLAN data communication using an antenna beam indicated in the notification after receiving the notification of the antenna beam direction from the information managing unit 4.

The timing for sending the WLAN connection notification may be of, for example, when the WLAN apparatus unit 2 determines a WLAN channel to be used using Scan or the like, when the WLAN apparatus unit 2 transmits or receives a control frame of the WLAN such as Probe, Authentication or Association, or when 4 way-handshake is started or ended. The WLAN connection notification only has to be sent at any one of the timings.

In the control operation explained above, the directionality control for the WLAN antenna 21 is performed based on only the location information of the BT terminal 12. However, the directionality control may be carried out only when the number of usable FH channels of AFH in the BT terminal 12 may be acquired and the number of usable FH channels of AFH is insufficient (when the number of FH channels is equal to or smaller than a specified threshold).

The interference avoiding method in the case of starting the WLAN communication after starting the BT communication is explained above. An interference avoiding method in the case of starting the BT communication after starting the WLAN communication is explained below.

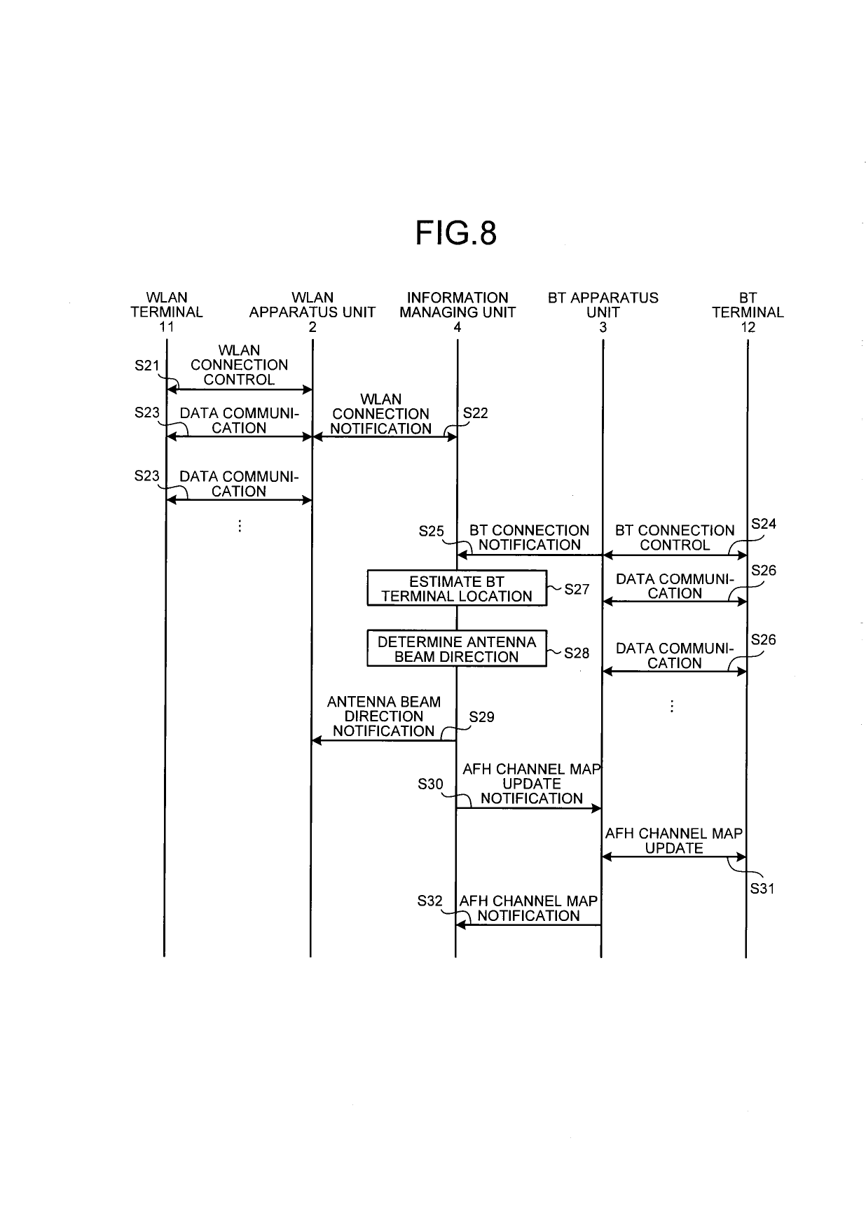

FIG. 8 is a flowchart for explaining an example of the interference avoiding method in the case of starting the BT communication after starting the WLAN communication.

In an operation conforming to a sequence shown in FIG. 8, first, the WLAN apparatus unit 2 of the wireless communication apparatus 1 performs WLAN connection processing between the WLAN apparatus unit 2 and the WLAN terminal 11 (step S21), sends a WLAN connection notification to the information managing unit 4, and starts data transmission and reception by the WLAN communication (steps S22 and S23). The processing in these steps is processing same as in the steps S5 to S7 explained above.

After executing the processing at steps S21 to S23, the BT apparatus unit 3 of the wireless communication apparatus 1 performs BT connection processing between the BT apparatus unit 3 and the BT terminal 12 (step S24), sends, to the information managing unit 4, a BT connection notification for notifying that BT connection has been completed (step S25), and starts data transmission and reception between the BT apparatus unit 3 and the BT terminal 12 (step S26). The processing in these steps is processing same as in the steps S1 to S3 explained above.

Subsequently, the information managing unit 4 performs location estimation for the BT terminal 12 according to a procedure same as in the step S4 explained above (step S27). Further, the information managing unit 4 determines an antenna beam direction and notifies the WLAN apparatus unit 2 of the determined antenna beam direction according to a procedure same as in the steps S8 and S9 explained above (steps S28 and S29). Upon receiving the antenna beam direction notification, the WLAN apparatus unit 2 communicates with the WLAN terminal 11 using an antenna beam included in the notification.

An AFH channel map in the communication between the BT apparatus unit 3 and the BT terminal 12 is created in a state in which a WLAN channel is used between the WLAN apparatus unit 2 and the WLAN terminal 11. For the reason, it is necessary to reflect a change in a channel use state resulting from the beam control for the WLAN antenna 21 onto the AFH channel map. Therefore, after making notification of the WLAN antenna beam direction at the step S29, the information managing unit 4 sends a notification of update of the AFH channel map to be used to the BT apparatus unit 3 and instructs the BT apparatus unit 3 to update the AFH channel map (step S30).

The BT apparatus unit 3 that has received the AFH channel map update notification updates the AFH channel map used for the BT communication between the BT apparatus unit 3 and the BT terminal 12 (step S31).

After the update of the AFH channel map is completed, the BT apparatus unit 3 sends an AFH channel map notification in which the updated AFH channel map information is stored, to the information managing unit 4 (step S32). In the information managing unit 4 that has received the AFH channel map notification, the received AFH channel map is provided to the BT managing unit 42. The BT managing unit 42 updates the AFH channel map information stored in the BT-information storing unit 422.

In the example of the interference avoidance sequence explained with reference to FIGS. 4 and 8, when the WLAN communication and the BT communication are simultaneously performed, the NULL point of the WLAN antenna beam is directed to the direction in which the BT terminal 12 is located, irrespective of an AFH channel map state. However, while referring to the AFH channel map, the directionality of the WLAN antenna may be controlled only when the number of usable FH channels is smaller than the threshold.

When the BT terminal 12 has been disconnected (when the simultaneous communication of the BT terminal 12 and the WLAN terminal 11 has been completed), the WLAN antenna beam may be set back to have a normal beam form (a state before the steps S8 and S9 in FIG. 4 and the steps S28 and S29 in FIG. 8 are executed).

In this embodiment, the BT communication system is explained as an example of the communication system performing frequency hopping. However, a communication system to be applied is not limited to the BT communication as long as the communication system is a communication system performing frequency hopping. The WLAN communication is explained as an example of the communication system using the same frequency band as the communication system performing frequency hopping. However, a communication system to be applied is not limited to the WLAN communication as long as the communication system is a wireless communication system in which the above-mentioned control of the information managing unit 4 is possible.

As explained above, in this embodiment, when the WLAN terminal and the BT terminal simultaneously perform communication, the location of the BT terminal is estimated by checking a communication quality (e.g., presence or absence of occurrence of a packet error) of the BT communication performed when the directionality of the directional antenna used by the WLAN apparatus is sequentially changed, and the WLAN antenna beam is controlled based on a result of the estimation. Specifically, the WLAN antenna is adjusted to direct a NULL point of the directionality toward the estimated location of the BT terminal. Consequently, it is possible to suppress interference between the WLAN communication and the BT communication. Further, because the BT communication is not affected by the WLAN communication, a channel used for the WLAN communication can be used as an FH channel for the BT communication. Therefore, it is possible to improve the communication quality of BT.

### Second Embodiment

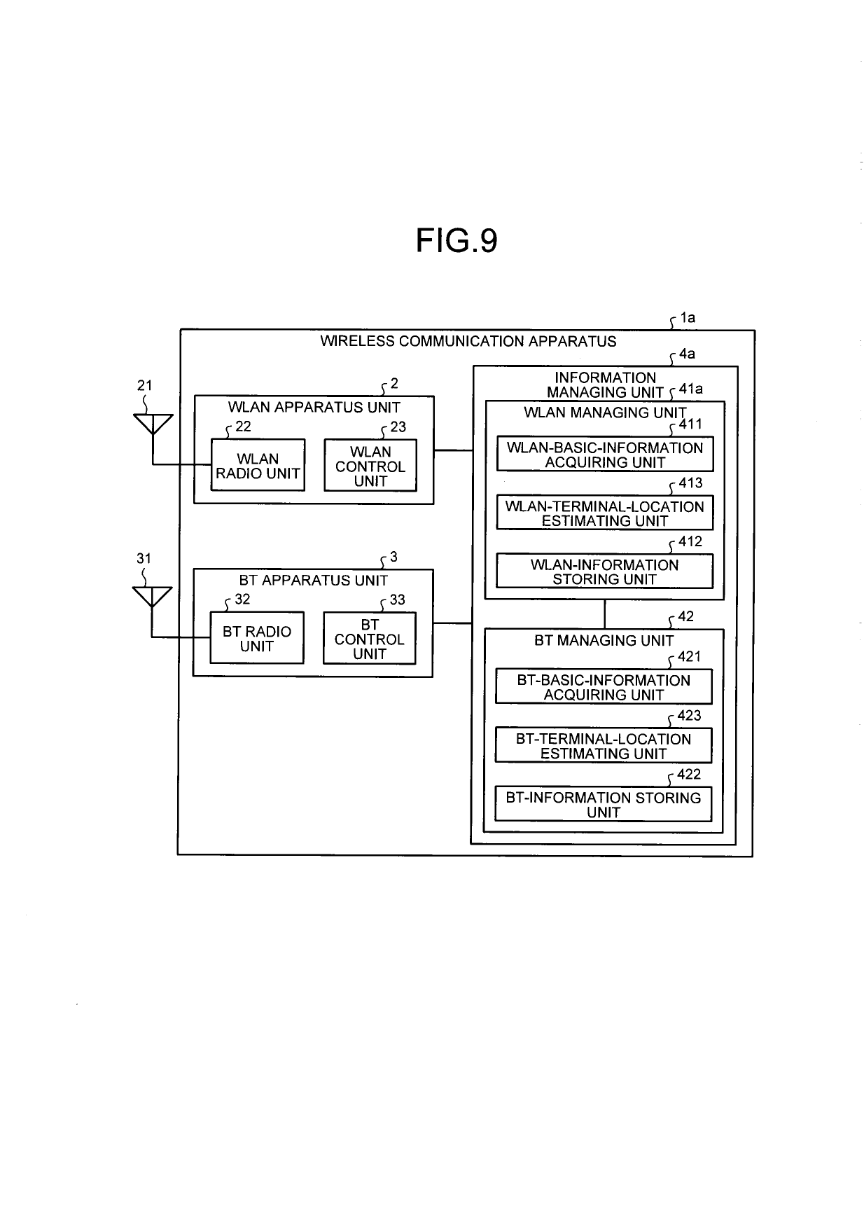

FIG. 9 is a diagram of a configurational example of a second embodiment of the wireless communication apparatus according to the present invention. As shown in the figure, in a wireless communication apparatus 1a according to this embodiment, the information managing unit 4 included in the wireless communication apparatus 1 according to the first embodiment shown in FIG. 1 is replaced with an information managing unit 4a including a WLAN managing unit 41a and the BT managing unit 42. In the WLAN managing unit 41a, a WLAN-terminal-location estimating unit 413 that estimates the location of a WLAN terminal to be connected is added to the WLAN managing unit 41 explained in the first embodiment. In FIG. 9, components common with the wireless communication apparatus 1 explained in the first embodiment are denoted by reference symbols same as those in the wireless communication apparatus 1. In this embodiment, differences from the first embodiment are mainly explained.

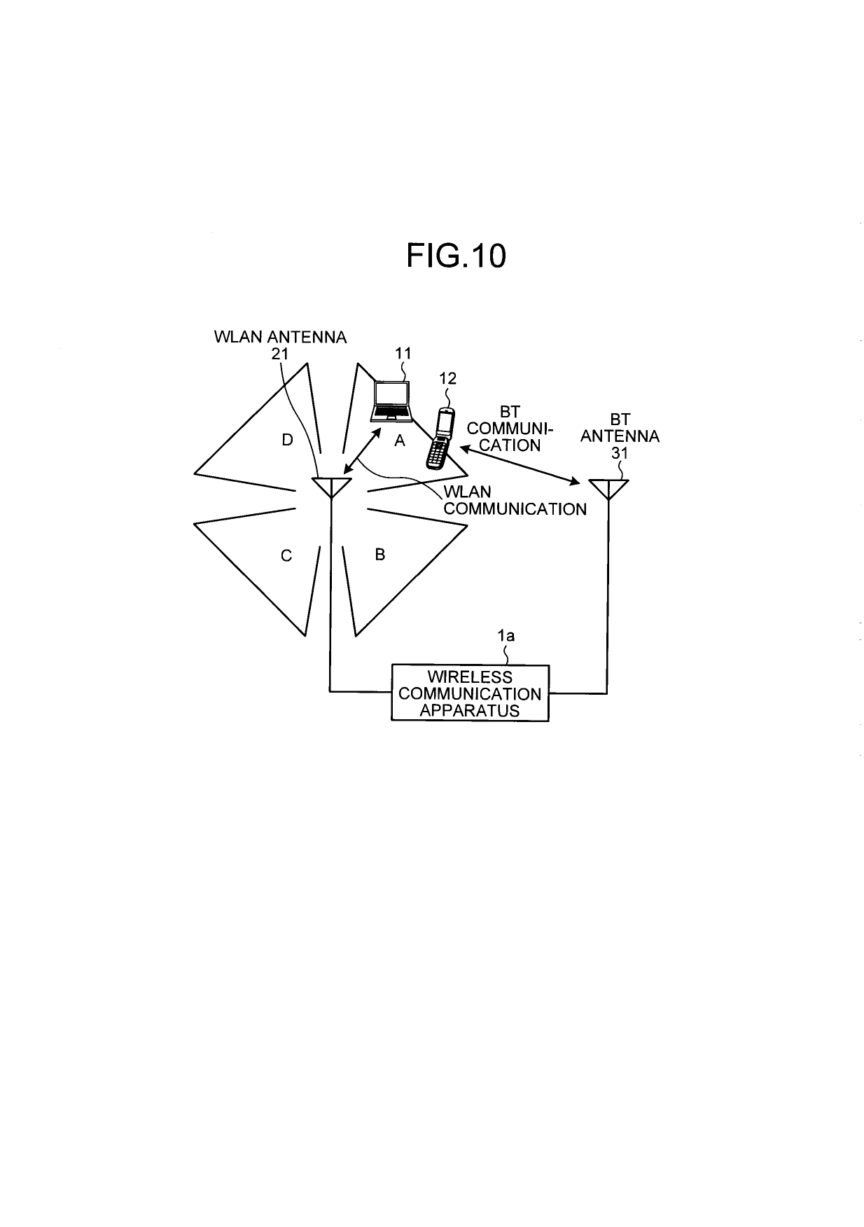

A configuration example of a wireless communication system including the wireless communication apparatus 1a according to the present invention is the same as in the first embodiment (see FIG. 2). In this embodiment, it is assumed that, as shown in FIG. 10, the WLAN antenna 21 has directionality in four directions and the WLAN terminal 11 and the BT terminal 12 are located in the same direction. In FIG. 10, the WLAN terminal 11 and the BT terminal 12 are located in the A direction of the WLAN beam, but the herein-illustrated arrangement thereof is not specifically limitation as long as the WLAN terminal 11 and the BT terminal 12 are located in the same direction. Although the WLAN antenna 21 has the directionality in the four directions, the number of sectors of the WLAN antenna 21 is not specifically limited. Further, the WLAN apparatus unit 2 and the WLAN terminal 11 that communicates with the WLAN apparatus unit 2 in this embodiment support a plurality of frequency bands (e.g., 2.4 GHz and 5 GHz).

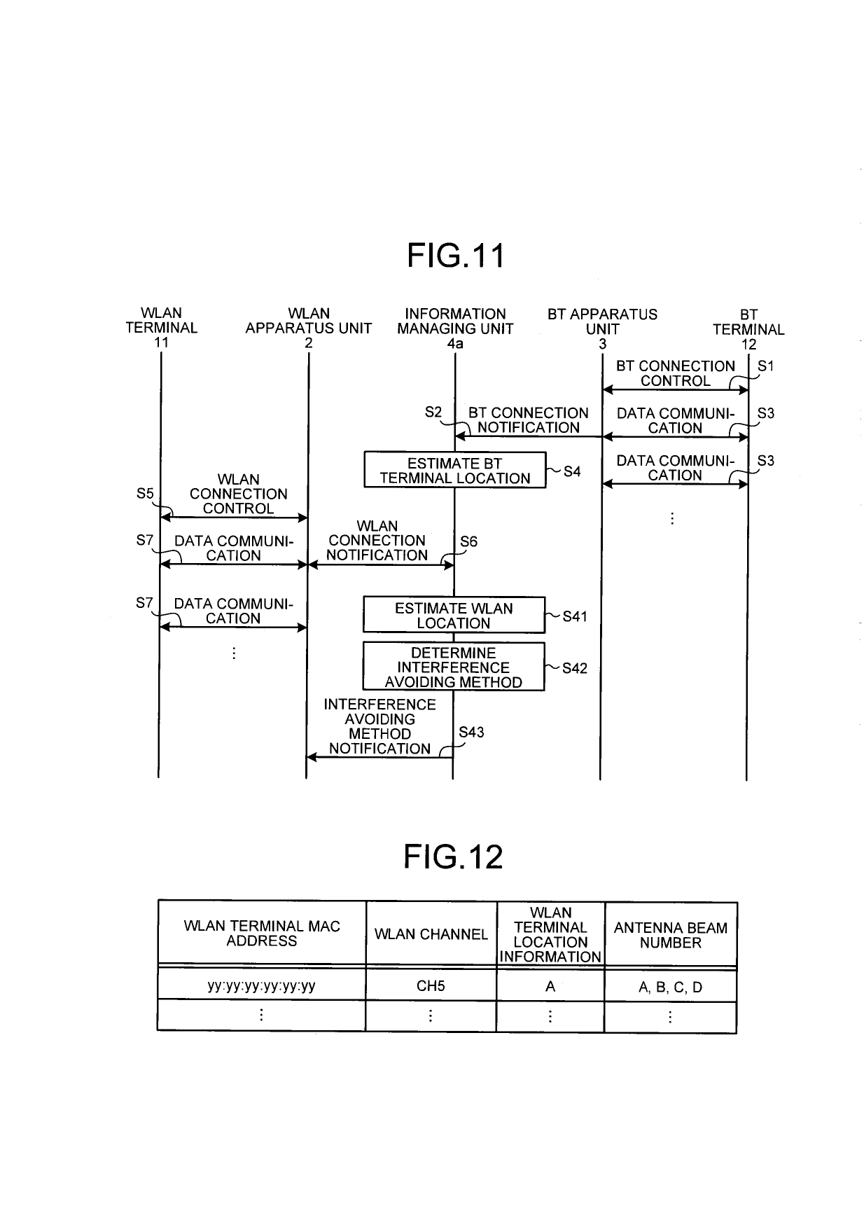

An interference avoiding method according to this embodiment is explained with reference to FIG. 11. FIG. 11 is a sequence chart for explaining an example of the interference avoiding method according to this embodiment. In FIG. 11, a sequence based on the configurations shown in FIGS. 2 and 10 is shown in which the BT terminal 12 is connected to the wireless communication apparatus 1a, and subsequently the WLAN terminal 11 is connected to the wireless communication apparatus 1a. In FIG. 11, the same step numbers are affixed to processes same as the processes described in FIG. 4 used in the explanation of the first embodiment. In this embodiment, explanation of the processes affixed with the same step numbers as the processes of FIG. 4 is omitted.

After the steps S1 to S6 explained with reference to FIG. 4 in the first embodiment are executed, in the information managing unit 4a that has received the WLAN connection notification transmitted at the step S6, the WLAN managing unit 41a is notified that the WLAN terminal 11 is connected. The WLAN managing unit 41a that has received this notification causes the WLAN-terminal-location estimating unit 413 to estimate the location of the WLAN terminal 11 (step S41). The WLAN-terminal-location estimating unit 413 estimates, for example, in which beam direction of the WLAN antenna 21 the WLAN terminal 11 is present. The WLAN-terminal-location estimating unit 413 instructs the WLAN apparatus unit 2 to transmit data only in a designated specific direction and check a response to this transmission from the WLAN terminal 11. The WLAN-terminal-location estimating unit 413 executes this processing for all the beam directions and estimates that the WLAN terminal 11 is located in a direction in which a response is issued. A location estimating method for the WLAN terminal 11 is not specifically limited. For example, the location of the WLAN terminal 11 may be estimated from a reception power in each antenna beam. A location estimation result for the WLAN terminal 11 is stored in the WLAN-information storing unit 412. Stored contents are set, for example, as shown in FIG. 12. In an example shown in FIG. 12, a MAC address of the WLAN terminal 11, a WLAN channel, location information of the WLAN terminal (herein, set to be a beam direction of the WLAN antenna), and a WLAN antenna beam number of a WLAN antenna to be used (in an initial state, because of non-directionality, all of A, B, C and D) are stored in association with one another. Stored contents are not limited to the above.

Upon recognizing simultaneous connection of the BT terminal 12 and the WLAN terminal 11, the information managing unit 4a determines a method of avoiding interference between the WLAN communication and the BT communication (step S42). Means for determining the interference avoiding method are explained below.

Upon determining the interference avoiding method at the step S42, the information managing unit 4a notifies the WLAN apparatus unit 2 of information for executing the determined interference avoiding method (step S43). For example, when a WLAN antenna beam direction is changed, the information managing unit 4a makes notification of the same information as the information in the first embodiment. When a WLAN frequency band is changed as in this embodiment, the information managing unit 4a makes notification of a changed frequency band. The change in a frequency is performed using a method such as Dynamic Frequency Selection (DFS) described in IEEE802.11h, for example.

In FIG. 11, a sequence example in the case where, after starting the WLAN data communication, the WLAN location estimation is performed to determine an interference avoiding method is shown. However, the WLAN data communication (step S7) may be started after the location of the WLAN terminal 11 is estimated and an interference avoiding method is determined at the steps S41 and S42.

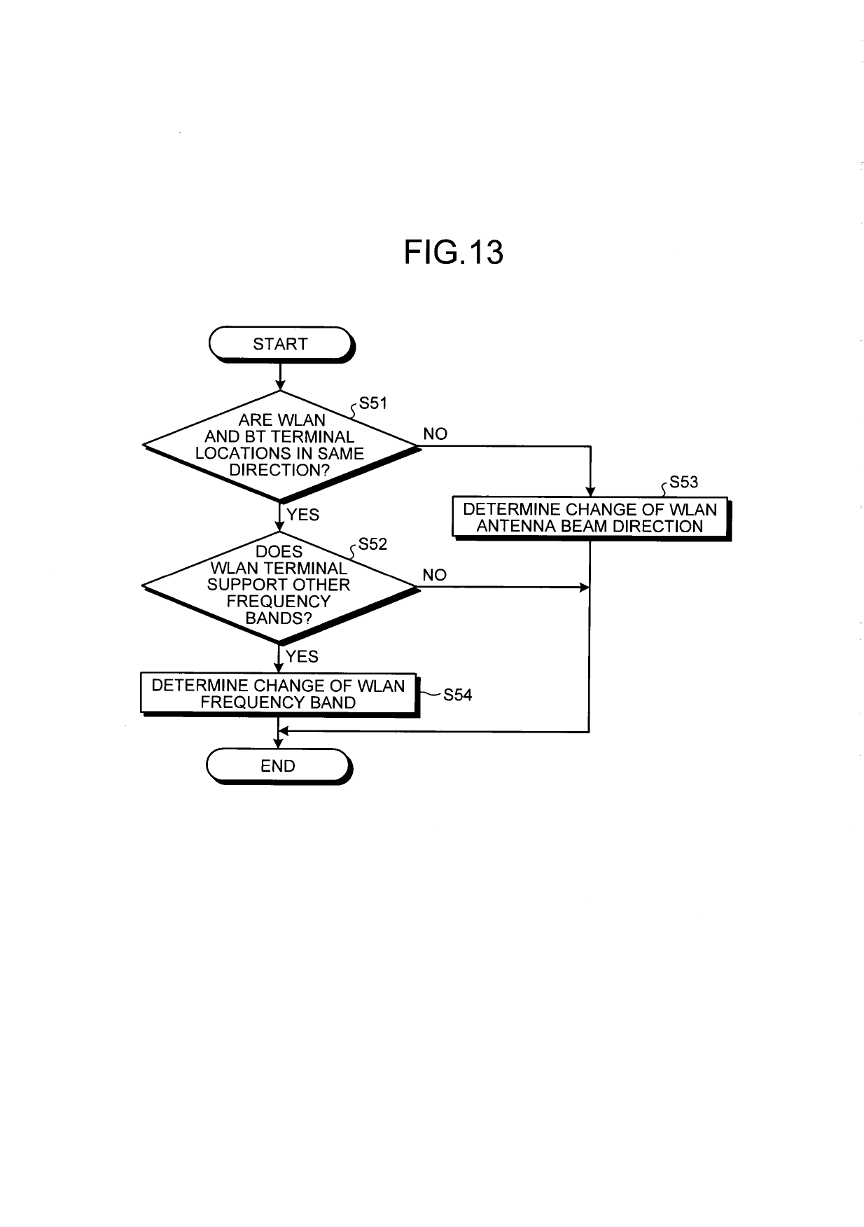

Now, an operation for determining a method of avoiding interference between the WLAN communication and the BT communication at the step S42 is explained. FIG. 13 is a flowchart for explaining an example of the operation for determining an interference between the WLAN communication and the BT communication. It is noted that FIG. 13 is just one example, and the order and contents of the processing are not limited to those shown in FIG. 13, and that any method may be adopted as long as it is possible to change a frequency used for the WLAN communication and avoid the interference when the WLAN terminal and the BT terminal are located in the same direction.

In the interference avoiding method determining operation shown in FIG. 13, first, the information managing unit 4a checks location information of the WLAN terminal 11 and location information of the BT terminal 12 stored in the WLAN-information storing unit 412 and the BT-information storing unit 422, and then determines whether or not the BT terminal 12 and the WLAN terminal 11 are located in the same direction (step S51). When these terminals are not located in the same direction (No at step S51), the information managing unit 4a performs the control explained in the first embodiment and determines a beam direction of the WLAN antenna 21 (step S53). In other words, as with the step S8, the information managing unit 4a determines a beam direction of the WLAN antenna 21 to direct a NULL point of the directionality to a direction in which the BT terminal 12 is located.

On the other hand, when the BT terminal 12 and the WLAN terminal 11 are located in the same direction (Yes at step S51), the WLAN managing unit 41a refers to information stored in the WLAN-information storing unit 412 and checks whether or not the WLAN terminal 11 supports other frequency bands (step S52). When the WLAN terminal 11 does not support other frequency bands (No at the step S52), the processing is ended. On the other hand, when the WLAN terminal 11 supports other frequency bands (Yes at the step S52), the WLAN managing unit 41a determines to change a frequency band to be used for the WLAN communication and avoid the interference (step S54). In this embodiment, only one WLAN terminal 11 is connected. However, when a plurality of WLAN terminals are connected, the WLAN managing unit 41a checks support states of all the terminals. When the WLAN apparatus unit 2 and the WLAN antenna 21 support simultaneous use of different frequency bands, only a frequency band of a relevant WLAN terminal (a WLAN terminal located in a direction same as the direction of the BT terminal 12) may be changed.

In the interference avoiding method determining sequence example shown in FIG. 13, when the WLAN terminal 11 and the BT terminal 12 simultaneously perform communication, an interference avoiding method is determined irrespective of the AFH channel map. However, with referring to the AFH channel map, an interference avoiding method (change of a beam direction of the WLAN antenna 21 and change of a frequency band used in the WLAN communication) may be determined only when the number of usable FH channel is smaller than a threshold.

In this embodiment, when the WLAN terminal 11 and the BT terminal 12 are located in the same WLAN antenna beam direction, a frequency band used for the WLAN communication is changed according to a situation. However, when the BT terminal 12 is disconnected or when the BT terminal 12 moves to a different WLAN beam direction, the frequency band may be set back to an original frequency band and use the interference avoiding method explained in the first embodiment.

In the example explained in the sequence shown in FIG. 11, the WLAN communication is started after the start of the BT communication. However, much the same is true on an operation in starting the BT communication after starting the WLAN communication.

In this embodiment, the BT communication system is explained as an example of the communication system performing frequency hopping. However, a communication system is not limited to the BT communication as long as the communication system is a communication system performing frequency hopping. The WLAN communication is explained as an example of the communication system using the same frequency band as the communication system performing frequency hopping. However, a communication system is not limited to the WLAN communication as long as the communication system is a wireless communication system in which the control of the information managing unit 4a is possible.

As explained above, in this embodiment, when the WLAN terminal and the BT terminal simultaneously perform communication, the location of the BT terminal is estimated by checking a communication quality (e.g., presence or absence of occurrence of a packet error) of the BT communication performed when the directionality of the directional antenna used by the WLAN apparatus is sequentially changed, the location of the WLAN terminal is estimated by sequentially changing the directionality of the directional antenna used by the WLAN apparatus, transmitting data addressed to the WLAN apparatus, and checking presence or absence of a response to the data transmission, and based on the estimation results, a frequency band in use in the WLAN communication is changed or a WLAN antenna beam is controlled to adjust the WLAN antenna to direct a NULL point of the directionality toward the estimated location of the BT terminal. Consequently, even when the WLAN terminal and the BT terminal are located in the same direction, it is possible to suppress interference between the WLAN communication and the BT communication. Because the BT communication is not affected by the WLAN communication, a channel used for the WLAN communication can be used as an FH channel for the BT communication. Therefore, it is possible to improve the communication quality of BT. Further, it is possible to avoid an unnecessary frequency change by performing, taking into account the AFH channel map, changing of a frequency band only when the number of channels useable in AFH is insufficient.

### Third Embodiment

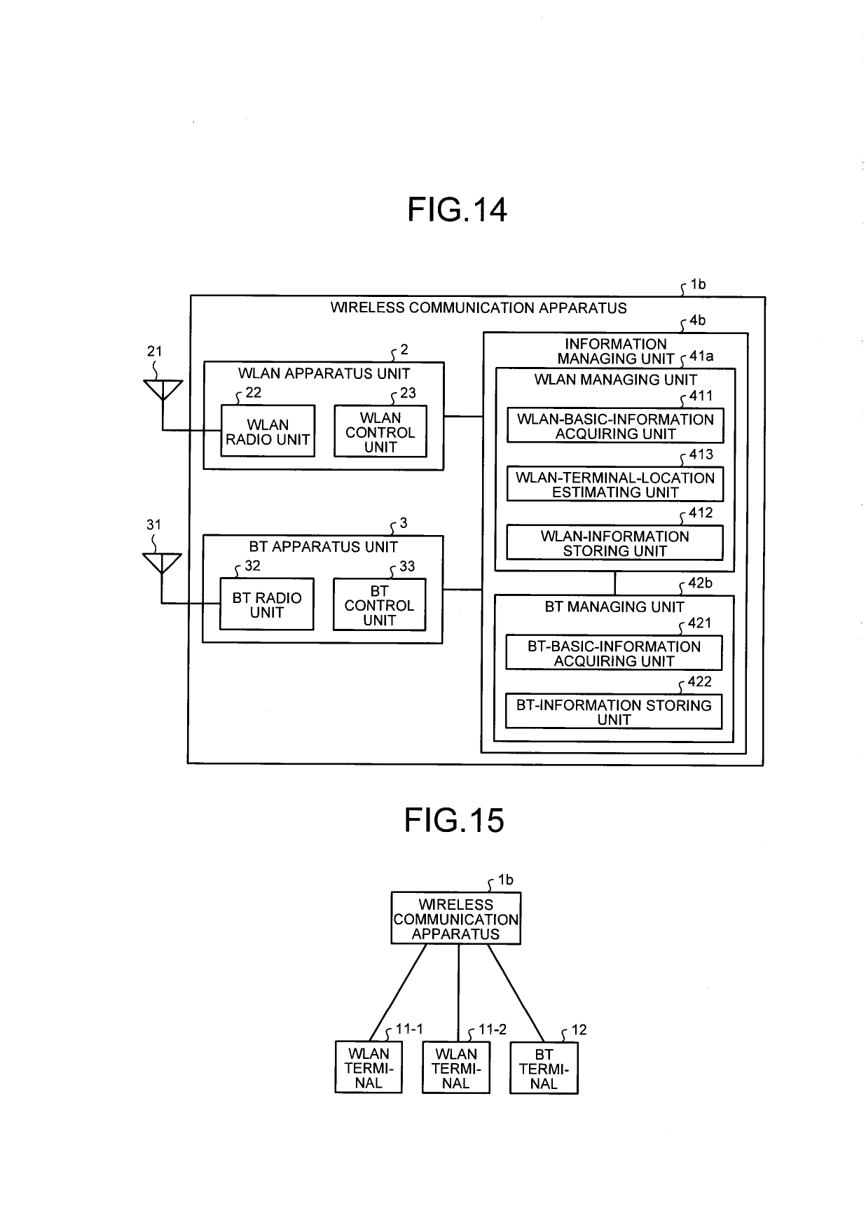

FIG. 14 is a diagram of a configurational example of a third embodiment of a wireless communication apparatus according to the present invention. As shown in the figure, in a wireless communication apparatus 1b according to this embodiment, the information managing unit 4a included in the wireless communication apparatus 1a according to the second embodiment shown in FIG. 9 is replaced with an information managing unit 4b including the information managing unit 41a and a BT managing unit 42b. In the BT managing unit 42b, the BT-terminal-location estimating unit 423 is deleted from the BT managing unit 42 explained in the first embodiment. In FIG. 14, components common with the wireless communication apparatuses 1 and 1a explained in the first and second embodiments are denoted by reference symbols same as those in the wireless communication apparatuses 1 and 1a. In this embodiment, differences from the first and second embodiments are mainly explained.

FIG. 15 is a diagram of a configurational example of a wireless communication system including the wireless communication apparatus according to the third embodiment. As shown in FIG. 15, the wireless communication system includes the wireless communication apparatus 1b shown in FIG. 14, a plurality of WLAN terminals 11-1 and 11-2 that perform WLAN communication, and the BT terminal 12 that performs BT communication.

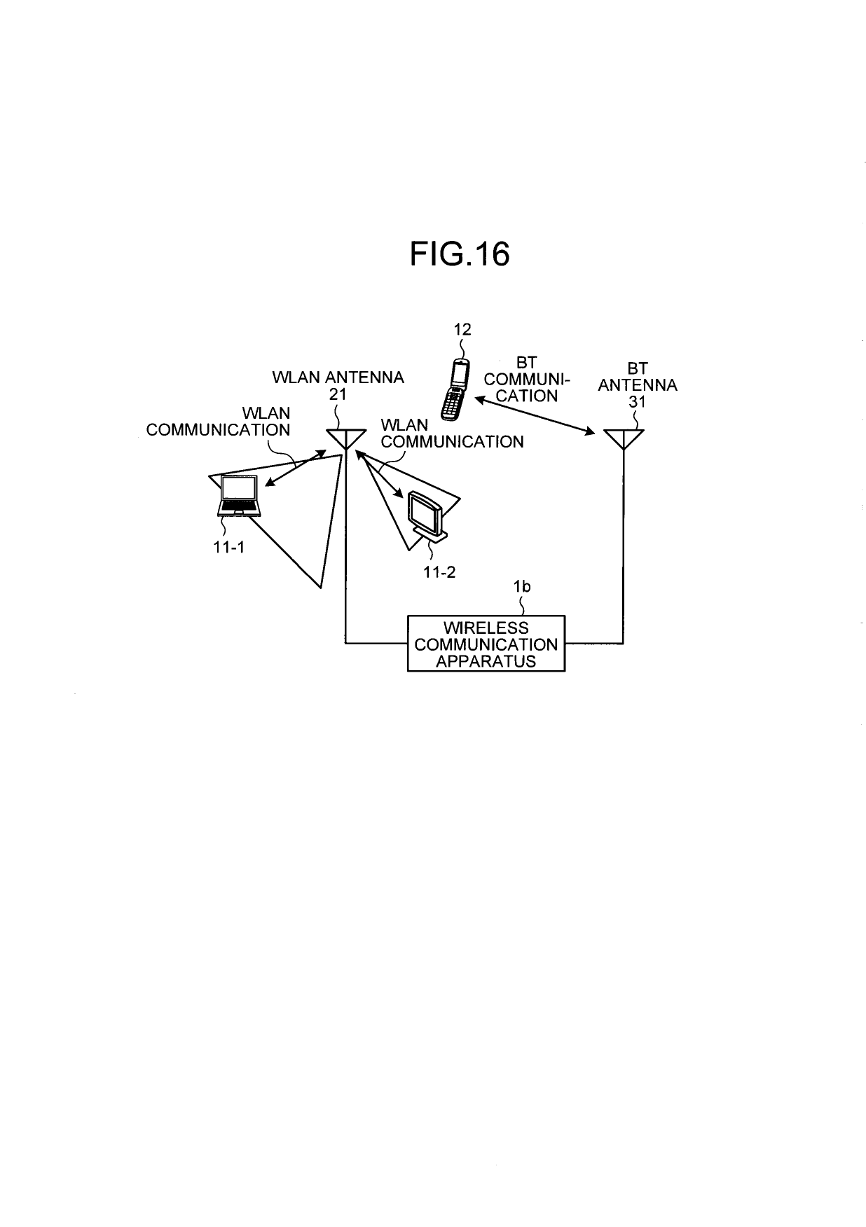

In this embodiment, it is assumed that, as shown in FIG. 16, the WLAN antenna 21 is capable of forming an antenna beam in an arbitrary direction and capable of adjusting an antenna beam angle (a radiation angle of a radio wave). The WLAN antenna 21 may be any antenna as long as a beam angle of the antenna can be adjusted. A type of the antenna is not specifically limited to a smart antenna, a phased array antenna, a sector antenna, or the like.

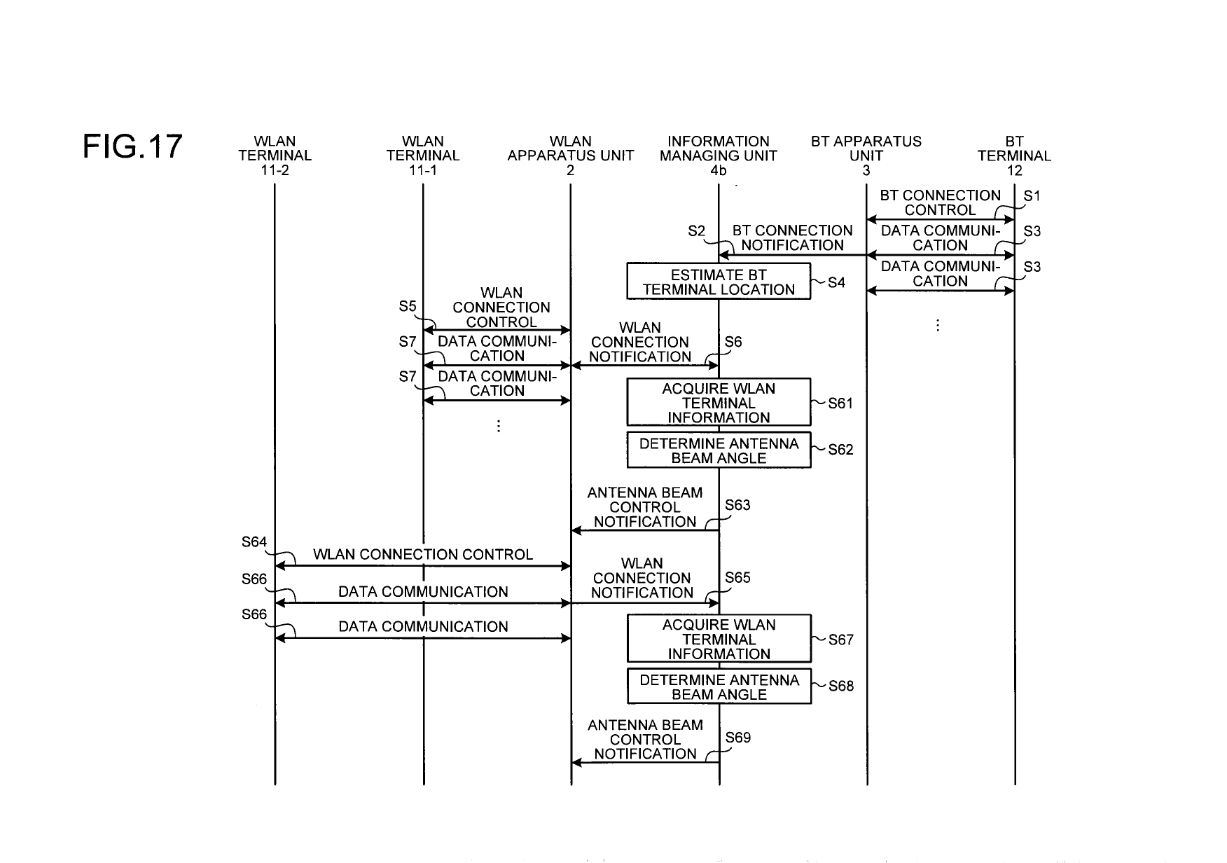

An interference avoiding method according to this embodiment is explained with reference to FIG. 17. FIG. 17 is a sequence chart for explaining an example of the interference avoiding method according to this embodiment. In FIG. 17, a sequence based on the configurations shown in FIGS. 15 and 16 is shown, in which the BT terminal 12 is connected to the wireless communication apparatus 1b, and subsequently the WLAN terminal 11-1 (e.g., a notebook PC) is connected to the wireless communication apparatus 1b, whereafter the WLAN terminal 11-2 (e.g., a stationary display) is connected to the wireless communication apparatus 1b. In FIG. 17, the same step numbers are affixed to processes same as the processes described in FIGS. 4 and 11 used in the explanation of the first and second embodiments. In this embodiment, explanation of the processes affixed with the same step numbers as the processes of FIGS. 4 and 11 is omitted.

In the wireless communication system according to this embodiment, first, the processing at the steps S1 to S3 explained in the first embodiment is executed between the BT apparatus unit 3 of the wireless communication apparatus 1b and the BT terminal 12 to start BT data communication. Subsequently, the processing at the steps S5 to S7 explained in the first embodiment is executed between the information managing unit 4b and WLAN apparatus unit 2 of the wireless communication apparatus 1b, and the WLAN terminal 11-1, and the WLAN apparatus unit 2 and the WLAN terminal 11-1 start WLAN data communication.

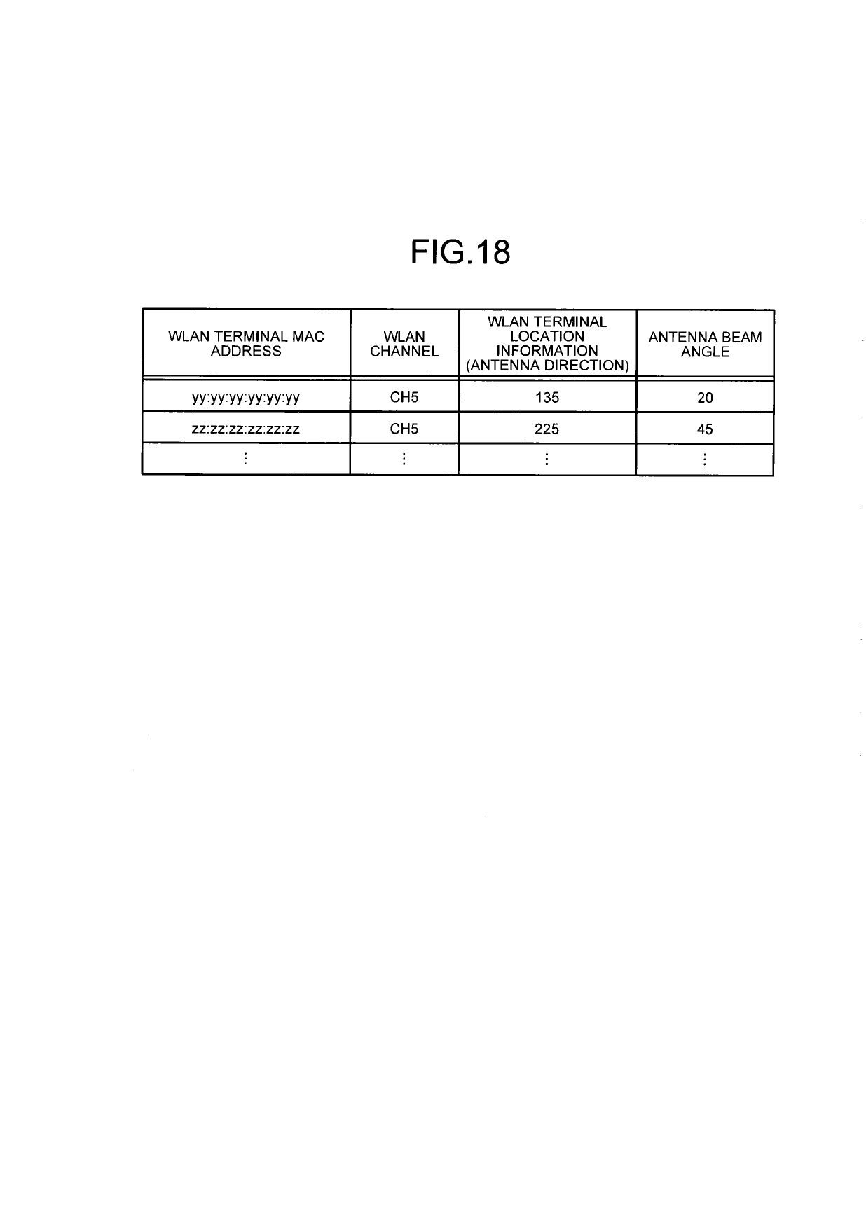

In the information managing unit 4b, upon receiving the WLAN connection notification transmitted at the step S6, the WLAN managing unit 41a acquires location information, device information, mobility and the like of the WLAN terminal 11-1 as WLAN terminal information of the WLAN terminal 11-1 (step S61). A method for the acquisition is explained below. The WLAN-information storing unit 412 stores the WLAN terminal information acquired by the WLAN managing unit 41a. Stored contents are, for example, set as shown in FIG. 18. In FIG. 18, there is shown an example of the case where a MAC address of a WLAN terminal, a WLAN channel, location information of the WLAN terminal (e.g., an antenna direction in which the terminal is located), and an antenna beam angle are stored in association with one another.

After acquiring the WLAN terminal information, upon recognizing connection of another radio device that uses the same frequency band (in this example, recognizing connection of the BT terminal 12), the WLAN managing unit 41a of the information managing unit 4b determines a beam angle of the WLAN antenna 21 based on the WLAN terminal information (step S62). In this embodiment, the WLAN terminal 11-1 is assumed to be a notebook PC. It is expected that the WLAN terminal 11-1 moves. Therefore, the WLAN managing unit 41a forms a wide-range WLAN antenna beam (increases a setting value of the antenna beam angle) anticipating in advance that a communication area changes according to the movement of the PC. The antenna beam angle can be arbitrarily set by the WLAN managing unit 41a.

The WLAN managing unit 41a of the information managing unit 4b transmits an antenna beam control notification including WLAN antenna beam information indicating a determination result at the step S62 to the WLAN apparatus unit 2 (step S63). The WLAN apparatus unit 2 controls the WLAN antenna 21 according to the acquired WLAN antenna beam information and adjusts an angle of an antenna beam used in communication with the WLAN terminal 11-1.

Thereafter, steps S64 to S66 are executed between the information managing unit 4b and WLAN apparatus unit 2 of the wireless communication apparatus 1b and the WLAN terminal 11-2 and the WLAN apparatus unit 2 and the WLAN terminal 11-2 start WLAN data communication. These steps S64 to S66 are the same as the processing executed when the WLAN terminal 11-1 starts the WLAN data communication. In other words, in the steps S64 to S66, the processing in the steps S5 to S7 explained in the first embodiment are executed.

In the information managing unit 4b, upon receiving, at the step S65, a WLAN connection notification indicating connection with the WLAN terminal 11-2, as with the steps S61 to S63, the WLAN managing unit 41a acquires location information, device information, mobility and the like of the WLAN terminal 11-2 as WLAN terminal information of the WLAN terminal 11-2 and the WLAN-information storing unit 412 stores the WLAN terminal information (step S67). Further, the WLAN managing unit 41a determines a beam angle of the WLAN antenna 21 based on the WLAN terminal information acquired at the step S67 (step S68). In this embodiment, the WLAN terminal 11-2 is assumed to be a stationary display. It is expected that the WLAN terminal 11-2 does not move. Therefore, interference with WLAN terminals and BT terminals in the periphery is suppressed by forming a narrow-range WLAN antenna beam.

The WLAN managing unit 41a of the information managing unit 4b transmits an antenna beam control notification including WLAN antenna beam information indicating a determination result of the step S68 to the WLAN apparatus unit 2 (step S69). The WLAN apparatus unit 2 controls the WLAN antenna 21 according to the acquired WLAN antenna beam information and adjusts an angle of an antenna beam used in communication with the WLAN terminal 11-2.

In the sequence shown in FIG. 17, the antenna beam is adjusted after the data communication is started between the WLAN apparatus unit 2 and the WLAN terminals. However, after the WLAN apparatus unit 2 and the WLAN terminals are connected to each other, a waiting mode may be set until an angle of the antenna beam is determined by the information managing unit 4b, and then start the data communication using the antenna beam having the determined angle.

A method in which the WLAN managing unit 41a of the information managing unit 4b acquires location information, device information and the like of a WLAN terminal as WLAN terminal information is explained.

As in the second embodiment, the location information of the WLAN terminal can be acquired in a method of transmitting data in all the beam directions and identifying a direction in which it is received, a method of estimating the location information from a reception power in the antenna beams, or the like method. A method other than these methods may be adopted. A method of estimating the location of the WLAN terminal is not specifically limited.

The device information of the WLAN terminal (a type of the WLAN terminal) can be estimated from, for example, a MAC address of the terminal. The MAC address is composed of a 22-bit vendor code and a 24-bit product number. Therefore, it is possible to estimate a WLAN terminal vendor from the vendor code and estimate the terminal, mobility and the like. It is possible to improve estimation accuracy because the product number is taken into account. For example, when the vendor is a game manufacturer, the WLAN terminal is assumed to be a portable game machine, and so expected to have a high mobility. When the vendor is a display manufacturer, the WLAN terminal is assumed to be a stationary display, and so expected to have a low mobility.

The device information of the WLAN terminal can also be estimated from presence or absence of support of QoS. In IEEE802.11e, QoS is supported, and so a terminal that supports QoS is expected to be a terminal, reliability of which is regarded as important, such as a stationary display. The presence or absence of support of QoS can be acquired from QoS Capability of Association Request transmitted from the WLAN terminal, or the like.

Further, the device information of the WLAN terminal may be estimated from, for example, IEEE802.11a/b/g/n or supported rate information. The supported rate can be acquired from Supported Rates, Extended Supported Rate or the like of Probe Request, Association Request or the like transmitted from the WLAN terminal.

It is known, at the time of mounting a stationary display or the like installed in an automobile, that the stationary display does not move. Therefore, it is also possible to register the corresponding device information in advance.

As another method, it is also possible to estimate the device information from fluctuation in reception power between a wireless communication apparatus and the WLAN terminal. For example, the information managing unit 4b measures, for a fixed period, a reception power of a packet received by the WLAN apparatus unit 2 from the WLAN terminal and estimates the device information from a degree of fluctuation in the reception power. The WLAN terminal with a large fluctuation degree can be predicted to be a terminal having a high mobility. The WLAN terminal with a small fluctuation degree can be predicted to be a terminal having a low mobility. A measurement item is not limited to the reception power. For example, a bit error rate, a packet error rate, an RSSI (Received Signal Strength Indicator), an SINR (Signal to Interference and Noise Ratio), or the like can also be used. The respective kinds of information can also be acquired using a protocol for statistical information acquisition standardized in IEEE802.11k, or the like.

For each estimation, it is also possible to take into account the number of antennas of the terminal, peripheral access points, and/or the like.

In this embodiment, when kinds of communication performed using a plurality of same frequency bands are simultaneously performed (when simultaneous communication in the same frequency band is performed), the directionality control for the WLAN antenna is performed. However, the directionality of the WLAN antenna may be controlled irrespective of the number of peripheral terminals.

In this embodiment, the WLAN communication is explained as an example of a target of the directionality control. However, a communication system is not limited to the WLAN communication as long as the communication system is a wireless communication system in which the control by the information managing unit 4b is possible.

As in the wireless communication apparatuses 1 and 1a explained in the first and second embodiments, the BT managing unit 42b may have a BT-terminal-location estimating unit, and the WLAN managing unit 41a may determine, at the step S62 or the like, beam direction and angle of the WLAN antenna while seeing to it that a NULL point of the directionality is directed to a direction in which a BT terminal being subjected to connection is located.

As explained above, in this embodiment, when the WLAN terminal and the BT terminal simultaneously perform communication, the location of the communicating WLAN terminal is estimated, it is estimated whether or not the WLAN terminal is a terminal that moves during its communication (a type of the terminal is estimated), and a bean range (a beam direction and a beam angle) of the WLAN antenna having a directionality is adjusted based on the estimation results of the location and the type. Consequently, it is possible to suppress interference between kinds of communication performed using the same frequency band, such as between one WLAN communication and another WLAN communication and between BT communication and WLAN communication. A wide-range WLAN antenna beam is formed for a terminal having high mobility and a narrow-range WLAN antenna beam is formed for a terminal having low mobility. Consequently, it is possible to prevent communication of the terminal having high mobility from becoming unstable (prevent the communication from being easily disconnected due to its movement).

In the explanation in the embodiments, the same frequency band is used in the BT communication and the WLAN communication. However, even in an environment in which only parts of frequency bands used in the BT communication and the WLAN communication overlap with each other, it is possible to suppress the BT communication and the WLAN communication from interfering with each other by applying the control explained in the embodiments to the environment.

### INDUSTRIAL APPLICABILITY

As explained above, the wireless communication apparatus according to the present invention is useful as a wireless communication apparatus adapted to a plurality of kinds of communication systems. In particular, the wireless communication apparatus is suitable for a wireless communication apparatus capable of simultaneously performing, using the same frequency, communication performing frequency hopping and communication complied with another system.

### REFERENCE SIGNS LIST

1, 1a, 1b wireless communication apparatus
2 WLAN apparatus unit
3 BT apparatus unit
4, 4a, 4b information managing unit
11, 11-1, 11-2 WLAN terminal
12 BT terminal
21 WLAN antenna
22 WLAN radio unit
23 WLAN control unit
31 BT antenna
32 BT radio unit
33 BT control unit
41, 41a WLAN managing unit
42, 42b BT managing unit
411 WLAN-basic-information acquiring unit
412 WLAN-information storing unit
413 WLAN-terminal-location estimating unit
421 BT-basic-information acquiring unit
422 BT-information storing unit
423 BT-terminal-location estimating unit

1. A wireless communication apparatus comprising:
a first communication unit configured to perform wireless communication in which frequency hopping is used;
a second communication unit configured to perform wireless communication in a system different from a system of the first communication unit using a band including at least a part of a band used by the first communication unit and making use of a directional antenna whose directionality is controllable; and
a control unit configured to, upon detecting simultaneous communication performed by the first communication unit and the second communication unit, instruct the second communication unit to perform communication while adjusting a beam direction of the directional antenna and instruct the first communication unit to measure a communication quality, determine a directionality setting value of the directional antenna based on a result of the communication quality measurement obtained by the first communication unit, and instruct the second communication unit to perform communication using the determined directionality setting value.

2. The wireless communication apparatus according to claim 1, wherein the control unit estimates, based on the measurement result, a location of a terminal communicating with the first communication unit, and determines the directionality setting value to direct a NULL point of the directionality of the directional antenna toward the estimated location of the terminal.

3. The wireless communication apparatus according to claim 2, wherein the control unit is further adapted:
to estimate a location of a terminal with which the second communication unit is communicating; and
when estimating that a first terminal with which the first communication unit is communicating and a second terminal with which the second communication unit is communicating are located in the same direction, to check whether communication performed using a frequency band different from a frequency band currently used by the second communication unit and the second terminal is possible, and, if the communication performed using the different frequency band is possible, then change the communication of the second communication unit and the second terminal to the communication using the different frequency band.

4. The wireless communication apparatus according to claim 2, wherein the control unit determines, in processing for determining the directionality setting value, a radiation angle of a radio wave of a beam of the directional antenna based on a type of the terminal with which the second communication unit is communicating.

5. The wireless communication apparatus according to claim 2, wherein, as an operation for estimating a location of the terminal with which the first communication unit is communicating, the control unit is adapted:
to instruct the second communication unit to transmit dummy data while sequentially changing the beam direction of the directional antenna, at timing of when the first communication unit performs communication, in a frequency band same as a frequency band used by the first communication unit; and
to acquire, from the first communication unit, a measurement result of a communication quality during the transmission of the dummy data, and estimate the terminal location based on a fluctuation result of the communication quality indicated by the acquired communication quality measurement result.

6. The wireless communication apparatus according to claim 5, wherein the control unit is adapted to acquire the communication quality measurement result every time the beam direction changes and, when the acquired communication quality measurement result indicates occurrence of deterioration in the communication quality, set a beam direction corresponding to the communication quality measurement result as an estimation result of the terminal location.

7. The wireless communication apparatus according to claim 6, wherein, upon detecting the occurrence of deterioration in the communication quality, the control unit is adapted to end the control for causing the second communication unit to transmit the dummy data.

8. The wireless communication apparatus according to claim 5, wherein the control unit is adapted to acquire the communication quality measurement result every time the beam direction changes and, after acquiring the communication quality measurement result for each beam direction a predetermined number of times, analyze the acquired communication quality measurement result, and set, as an estimation result of the terminal location, a beam direction in which the communication quality for each of the beam directions is worst.

9. The wireless communication apparatus according to claim 2, wherein, as an operation for estimating a location of the terminal with which the first communication unit is communicating, the control unit is adapted:
to instruct the second communication unit to transmit dummy data while sequentially changing the beam direction of the directional antenna, at timing of when the first communication unit performs communication, in a frequency band same as a frequency band used by the first communication unit; and
to acquire, from the first communication unit, the number of frequency channels used in communication during the transmission of the dummy data, and estimate the terminal location based on a fluctuation result of the number of used frequency channels, that is the acquired number of frequency channels.

10. The wireless communication apparatus according to claim 9, wherein the control unit is adapted to acquire the number of used frequency channels every time the beam direction changes and, when the acquired number of used frequency channels is smaller than the number of used frequency channels, which has been acquired in another beam direction, set a beam direction corresponding to the acquired number of used frequency channels as an estimation result of the terminal location.

11. The wireless communication apparatus according to claim 9, wherein the control unit is adapted to acquire the number of used frequency channels every time the beam direction changes and, when the acquired number of used frequency channels is larger than the number of used frequency channels, which has been acquired in another beam direction, set NULL point directions of the beams corresponding to the acquired number of used frequency channels as an estimation result of the terminal location.

12. The wireless communication apparatus according to claim 2, wherein, as an operation for estimating a location of the terminal with which the first communication unit is communicating, the control unit is adapted to instruct the second communication unit to execute carrier sense while sequentially changing the beam direction of the directional antenna, at timing of when the first communication unit performs communication, in a frequency band same as a frequency band used by the first communication unit, and set, as an estimation result of the terminal location, a beam direction in which a reception power level equal to or higher than a predetermined threshold is detected.

13. The wireless communication apparatus according to claim 3, wherein the control unit is adapted to check the number of channels used in communication by the first communication unit and perform, when the number of channels is smaller than a predetermined threshold, control for changing the communication to communication performed using the different frequency band.

14-18. (canceled)

19. The wireless communication apparatus according to claim 1, wherein the control unit is adapted to check the number of channels used in the communication of the first communication unit and, when the number of channels is smaller than a predetermined threshold, perform processing for determining the directionality setting value.

20. The wireless communication apparatus according to claim 1, wherein, after detecting the simultaneous communication of the first communication unit and the second communication unit, upon detecting that the first communication unit disconnects the communication, the control unit is adapted to instruct the second communication unit to end the use of the determined directionality setting value, set the communication back to a state before the start of the use of the directionality setting value, and continue the communication.

21. The wireless communication apparatus according to claim 1, wherein, in starting communication, the second communication unit stays on standby until the directionality setting value is determined by the control unit and performs the communication using the determined directionality setting value.

22. A wireless communication apparatus comprising:
a first communication unit configured to perform radio communication in which frequency hopping is used;
a second communication unit configured to perform radio communication in a system different from a system of the first communication unit using a band including at least a part of a band used by the first communication unit and making use of a directional antenna whose directionality is controllable; and
a control unit configured to determine a radiation angle of a radio wave of a beam of the directional antenna based on a type of a terminal with which the second communication unit is communicating.

23-27. (canceled)

28. The wireless communication apparatus according to claim 22, wherein
the first communication unit performs communication conforming to a WLAN standard, and
the second communication unit performs communication conforming to a BT standard.

29. (canceled)

30. A wireless communication method implemented by a wireless communication apparatus having a first communication function and a second communication function when the wireless communication apparatus uses the first communication function and the second communication function at the same time, the first communication function being intended to perform wireless communication in which frequency hopping is used, and the second communication function being intended to perform wireless communication in a system different from a system of the first communication function, using a band including at least a part of a band used by the first communication function and making use of a directional antenna whose directionality is controllable, the wireless communication method comprising:
a direction checking step of determining whether a location of a first terminal that performs communication using the first communication function and a location of a second terminal that performs communication using the second communication function are in the same direction;
a frequency band changing step of checking, when it is determined at the direction checking step that the locations are in the same direction, whether communication performed using a frequency band different from a frequency band currently used by the second terminal is possible, and changing, if the communication performed using the different frequency band is possible, the communication to communication performed using the different frequency band; and
an antenna adjusting step of performing, when it is determined at the direction checking step that the locations are not in the same direction, communication of the second communication function while adjusting the beam direction of the directional antenna, measuring a communication quality of the communication of the first communication function, and adjusting a beam direction of the directional antenna based on a measurement result of the communication quality.

31. The wireless communication method according to claim 30, wherein, in the antenna adjusting step, a beam angle of the directional antenna is additionally adjusted based on a type of the second terminal.
